(19) United States
(12) Patent Application Publication
(10) Pub. No.: US 2014/0176655 A1
(43) Pub. Date: Jun. 26, 2014

(54) CONVEYANCE APPARATUS AND IMAGE FORMING APPARATUS

(71) Applicant: FUJIFILM CORPORATION, Tokyo (JP)

(72) Inventor: Kazumasa HATTORI, Kanagawa (JP)

(73) Assignee: FUJIFILM CORPORATION, Tokyo (JP)

(21) Appl. No.: 14/190,907

(22) Filed: Feb. 26, 2014

Related U.S. Application Data
(63) Continuation of application No. PCT/JP2012/062678, filed on May 17, 2012.

(30) Foreign Application Priority Data
Aug. 31, 2011 (JP) 2011-189551

(51) Int. Cl. B41J 13/08; B65H 5/08; B65H 3/10

(52) U.S. Cl. CPC B41J 13/08; B65H 3/10; B65H 5/085
USPC 347/104; 271/11

(57) ABSTRACT

A conveyance apparatus is provided with a conveyance body that suction adheres and conveys a sheet form medium, and a pressing body that presses the sheet form medium against a suction adhesion face of the conveyance body that suction adheres the sheet form medium, the paper press roller pressing more strongly portions that are present at plural locations along the suction adhesion face width direction where the suction adhesion force of the suction adhesion face is weak than the pressing body presses other portions. The pressing body of the conveyance apparatus includes large diameter portions that press the sheet form medium at plural locations along the width direction, thereby preventing lift-off of the sheet form medium at suction hole unformed regions that are portions where the suction adhesion force to the suction adhesion face of the conveyance body is weaker than in the vicinity thereof.

### CROSS-REFERENCE TO RELATED APPLICATION

This application is a continuation application of International Application No. PCT/JP/2012/062678, filed May 17, 2012, the disclosure of which is incorporated herein by reference in its entirety. Further, this application claims priority from Japanese Patent Application No. 2011-189551, filed Aug. 31, 2011, the disclosure of which is incorporated herein by reference in its entirety.

### BACKGROUND OF THE INVENTION

1. Field of the Invention

The present invention relates to a conveyance apparatus and an image forming apparatus, and in particular relates to a conveyance apparatus capable of effectively preventing lift-off between a sheet form medium and a suction adhesion face of a conveyance body and an image forming apparatus provided with the conveyance apparatus.

2. Description of the Related Art

In inkjet image forming apparatuses, deformation of paper can occur immediately after printing due to ink density differences in an image region. In particular, in image forming apparatuses in which the ink is water based ink and the recording paper is general purpose paper, there are noticeable issues with deformation of paper immediately after printing.

As a conveyance apparatus that prevents paper deformation in an image forming apparatus, a conveyance drum exists that includes a barrel provided along the axial direction with plural suction openings that extend around the circumferential direction, and a sheet shaped member that is mounted to an outer peripheral face of the barrel. An outside face of the sheet shaped member configures a medium retention face that retains a medium (Japanese Patent No. 4478897). In this conveyance drum, the medium retention member is divided into a suction hole formed region provided with multiple suction holes, and a suction hole unformed region where suction holes are not provided.

An inkjet recording apparatus also exists that is provided with a recording head formed with a nozzle that jets ink, and a support member that supports a recording medium. An image is recorded by jetting ink from the recording head so as to impact the recording medium supported on the support member whilst the recording medium is being conveyed in a uniform direction. The inkjet recording apparatus is provided with a press member that presses the recording medium against the support member at a recording medium conveyance direction upstream side of the recording head (Japanese Patent Application Laid-Open (JP-A) No. 2005-29333).

However, since in a conveyance drum formed with a suction hole formed region and a suction hole unformed region on the medium retention face, the medium retention face includes regions of high suction adhesion force and regions of low suction adhesion force with respect to the recording medium, for example paper. There is accordingly the possibility of paper lift-off occurring at low suction adhesion force regions.

Moreover, detecting lift-off of the paper, and then pressing portions at which lift-off has occurred with a press member, is not appropriate when performing high speed printing with single pass printing.

### SUMMARY

In order to address the above issues, an object of the present invention is to provide a conveyance apparatus that is capable of effectively preventing lift-off from occurring between a sheet form medium and a suction adhesion face of a conveyance body, and an image forming apparatus provided with the conveyance apparatus.

A first aspect of the present invention relates to a conveyance apparatus, and includes: a conveyance body that suction adheres and conveys a sheet form medium; and a pressing body that presses the sheet form medium against a suction adhesion face of the conveyance body that suction adheres the sheet form medium, the pressing body pressing more strongly portions of the suction adhesion face at plural locations along the suction adhesion face width direction where suction adhesion force is weaker than the pressing body presses other portions.

In the conveyance apparatus of the first aspect, the pressing body presses the portions on the suction adhesion face where suction adhesion force is weaker more strongly than the pressing body presses other portions on the suction adhesion face, even when the portions where suction adhesion force is weaker than at other locations are present at plural locations along the suction adhesion face width direction. Lift-off between the sheet form medium and the suction adhesion face can accordingly be prevented at the portions of the suction adhesion face where the suction adhesion force is weak.

A second aspect of the present invention is the conveyance apparatus of the first aspect, wherein the pressing body is a contact pressing body that contacts and presses the suction adhesion face of the conveyance body, and the pressing body includes a strong pressing portion that is closer to the conveyance body and a weak pressing portion that is further away from the conveyance body.

In the conveyance apparatus of the second aspect, the pressing body presses the suction adhesion face mechanically by contacting the suction adhesion face. Lift-off can accordingly be reliably prevented from occurring between the sheet form medium and the suction adhesion face at the portions of the suction adhesion face where the suction adhesion force is weak in comparison to when the pressing body presses the suction adhesion face non-mechanically by for example air pressure or static electricity. Moreover, since configuration is made such that the strong pressing portion is closer to the conveyance body than the weak pressing portion, when the pressing body presses the suction adhesion face of the conveyance body, the strong pressing portion presses the suction adhesion face more strongly than the weak pressing portion.

A third aspect of the present invention is the conveyance apparatus of the second aspect, wherein the contact pressing body is a rotating pressing body that rotates whilst contacting the conveyance body.

In the conveyance apparatus of the third aspect, damage to the suction sheet form medium that is being suction adhered and conveyed by the conveyance body due to friction between the between the conveyed sheet form medium and the pressing body is effectively prevented since the pressing body is a rotating pressing body that rotates whilst contacting the conveyance body.

A fourth aspect of the present invention is the conveyance apparatus of any one of the first aspect to the third aspect, wherein: the conveyance body is a conveyance drum that rotates about an axis; and the conveyance drum suction adhesion face is partitioned along the conveyance drum axial direction into a suction hole formed region where multiple suction holes are formed, and a suction hole unformed region where suction holes are not formed.

In the conveyance apparatus of the fourth aspect, the suction adhesion force at the suction hole unformed region is weaker than the suction adhesion force at the suction hole formed region. However, lift-off can be prevented from occurring between the suction adhesion face and the sheet form medium at the suction hole unformed region since the suction hole unformed region is pressed harder than the suction hole formed region by the pressing body.

A fifth aspect of the present invention is the conveyance apparatus of the fourth aspect, wherein: the pressing body is a rotating pressing body; and a strong pressing portion of the rotating pressing body presses the suction hole unformed region of the conveyance drum, and a weak pressing portion of the rotating pressing body presses the suction hole formed region of the conveyance drum.

In the conveyance apparatus of the fifth aspect, the suction hole unformed region of the conveyance drum is pressed harder than the suction hole formed region by the rotating pressing body since the suction hole unformed region of the conveyance drum is pressed by the strong pressing portion of the rotating pressing body, and the suction hole formed region of the conveyance drum is pressed by the weak pressing portion of the rotating pressing body.

A sixth aspect of the present invention is the conveyance apparatus of the fifth aspect, wherein the width of the strong pressing portion of the rotating pressing body is greater than the width of the suction hole unformed region of the conveyance drum.

In the conveyance apparatus of the sixth aspect, lift-off of the sheet form medium at the suction hole unformed region of the conveyance drum can be reliably prevented since the width of the strong pressing portion of the rotating pressing body is greater than the width of the suction hole unformed region of the conveyance drum.

A seventh aspect of the present invention is the conveyance apparatus of the fifth aspect, wherein the width of the strong pressing portion of the rotating pressing body is smaller than the width of the suction hole unformed region of the conveyance drum.

In the conveyance apparatus of the seventh aspect, the sheet form medium is not pressed by the strong pressing portion at the suction hole formed regions where the suction adhesion force is stronger, since the width of the strong pressing portion of the rotating pressing body is smaller than the width of the suction hole unformed region of the conveyance drum. Accordingly, damage to the sheet form medium and/or the suction adhesion face due to the rotating pressing body pressing with excessive force at the suction hole formed region can be effectively prevented.

An eighth aspect of the present invention is the conveyance apparatus of any one of the third aspect to the seventh aspect, wherein: the rotating pressing body is a press roller; the press roller is formed with plural large diameter portions that are the rotating pressing body strong pressing portions, and a small diameter portion that is the rotating pressing body weak pressing portion and has a smaller external diameter than the large diameter portions.

In the conveyance apparatus of the eighth aspect, when the press roller is pressed against the suction adhesion face of the conveyance body, the large diameter portions press more strongly than the small diameter portion since the large diameter portions are positioned closer to the conveyance body than the small diameter portion.

A ninth aspect of the present invention is the conveyance apparatus of any one of the third aspect to the seventh aspect, wherein: the rotating pressing body is a press belt; a face of the press belt on a side that presses the sheet form medium is formed with plural projecting portions running in the press belt rotation direction; and portions of the press belt formed with the projecting portions configure the rotating pressing body strong pressing portions, and a portion of the press belt not formed with the projecting portions configures the rotating pressing body weak pressing portion.

In the conveyance apparatus of the ninth aspect, when the press belt is pressed against the suction adhesion face of the conveyance body, the portions formed with the projecting portions press more strongly than the portion not formed with the projecting portions since the projecting portions of the press belt are closer to the conveyance body.

A tenth aspect of the present invention is the conveyance apparatus of any one of the fourth aspect to the seventh aspect, wherein the conveyance drum includes: a barrel provided with plural suction openings passing through to an inside negative pressure portion, the suction openings formed in an outer peripheral face around the circumferential direction; an intermediate sheet that is mounted to an outer peripheral face of the barrel, and that is provided with plural suction adhesion grooves around the barrel circumferential direction, the suction adhesion grooves extending in the axial direction and including narrowed portions facing the suction openings of the barrel; and a suction adhesion sheet that is mounted to an outside face of the intermediate sheet and that configures the suction adhesion face, with the suction holes formed in the suction hole formed region of the suction adhesion face being in communication with the suction adhesion grooves, and with the suction hole unformed region facing the narrowed portions.

In the conveyance apparatus of the tenth aspect, the narrowed portions of the suction adhesion grooves are covered by the suction hole unformed region of the suction adhesion sheet and are not in direct communication with the outside air, and thereby have a function of creating a pressure drop in the flow path formed by the suction holes and the suction adhesion grooves. A significant drop in the suction adhesion force of the sheet form medium onto the suction adhesion face can accordingly be prevented even when the sheet form medium is only sucked against a region of a portion of the suction adhesion face of the conveyance drum, or when the sheet form medium is not sucked against the suction adhesion face at all.

An eleventh aspect of the present invention is an image forming apparatus including: the conveyance apparatus of any one of the first aspect to the tenth aspect that suction adheres and conveys a sheet form medium on a suction adhesion face; and a liquid droplet jetting head that jets liquid droplets onto the sheet form medium that is being conveyed by the conveyance apparatus.

In the image forming apparatus of the eleventh aspect, portions of the suction adhesion face of the conveyance body provided to the conveyance apparatus where the suction adhesion force is weaker than at other portions are pressed more strongly by the pressing body than the other portions. Lift-off between the suction adhesion face and the sheet form medium can accordingly be prevented at the portions of the suction adhesion face where the suction adhesion force is weak.

A twelfth aspect of the present invention is the image forming apparatus of the eleventh aspect, wherein: the conveyance apparatus of any one of the second aspect to the tenth aspect is provided as the conveyance apparatus; and where d is a distance between the weak pressing portion of the pressing body and the sheet form medium when the sheet form medium is being conveyed by the conveyance apparatus, and Td is a distance between a liquid droplet jetting face of the liquid droplet jetting head and the sheet form medium, the distance d is set so as to satisfy the expression 0<d<Td.

In the image forming apparatus of the twelfth aspect, since the distance d between the weak pressing portion of the pressing body and the sheet form medium is greater than 0, a region of the sheet form medium corresponding to the weak pressing portion of the pressing body form is accordingly a non-pressed region that the pressing body does not press. When unevenness is present in the sheet form medium, the unevenness is accordingly pressed out into the non-pressed regions, thereby effectively preventing creasing that is caused by pressing. Moreover, since the distance d is smaller than the distance Td between the liquid droplet jetting face of the liquid droplet jetting head and the sheet form medium, even when lift-off between the sheet form medium and the suction adhesion face of the conveyance body would otherwise occur at the distance Td or above, this lift-off is pressed down to the height d or less by the pressing body. The sheet form medium that is being conveyed on the conveyance apparatus is accordingly prevented from making contact with the liquid droplet jetting face.

A thirteenth aspect of the present invention is the image forming apparatus of the twelfth aspect, wherein: the pressing body of the conveyance apparatus is the press roller of the eighth aspect, or the press belt of the ninth aspect; and a height d of a step between the large diameter portions and the small diameter portion of the press roller, or a height d of the projecting portions of the press belt, is set so as to satisfy the relationship expression of twelfth aspect.

In the image forming apparatus of the thirteenth aspect, the height d of the step can also be said to be the distance between the weak pressing portion of the pressing body and the sheet form medium. When the relationship 0<d<Td described in the twelfth aspect is satisfied between the step height d and the distance Td between the liquid droplet jetting face of the liquid droplet jetting head and the sheet form medium, for similar reasons as described above regarding the twelfth aspect, the occurrence in the sheet form medium of creasing that is caused by unevenness in the sheet form medium, and contact between the sheet form medium and the liquid droplet jetting face, can be prevented in the conveyance apparatus that is provided with the press roller or the press belt as the pressing body.

### Advantageous Effects of Invention

As described above, the present invention provides a conveyance apparatus that is capable of effectively preventing lift-off from occurring between a sheet form medium and a suction adhesion face of a conveyance body, and an image forming apparatus provided with the conveyance apparatus.

### BRIEF DESCRIPTION OF DRAWINGS

FIG. 1 is an overall configuration diagram illustrating an exemplary embodiment of an inkjet recording apparatus according to a first exemplary embodiment;

FIG. 2 is a block diagram illustrating a schematic configuration of a control system of the inkjet recording apparatus illustrated in FIG. 1;

FIG. 3 is a perspective view illustrating an overall configuration of an image recording drum provided to an image recording section of the inkjet recording apparatus illustrated in FIG. 1;

FIG. 4 is an exploded perspective view illustrating an internal configuration of the image recording drum illustrated in FIG. 3;

FIG. 5 is a perspective view illustrating a configuration of a drum body provided to the image recording drum illustrated in FIG. 3;

FIG. 6 is a laid-out view of an intermediate sheet provided to the image recording drum illustrated in FIG. 3;

FIG. 7 is an explanatory diagram illustrating a positional relationship between suction openings open in a suction adhesion face and suction adhesion grooves provided to an intermediate sheet of the image recording drum illustrated in FIG. 3;

FIG. 8 is an explanatory diagram illustrating a positional relationship between an example of a paper press roller and an image recording drum provided to an image recording section of the inkjet recording apparatus illustrated in FIG. 1;

FIG. 9 is an explanatory diagram illustrating a positional relationship between another example of a paper press roller and an image recording drum provided to an image recording section of the inkjet recording apparatus illustrated in FIG. 1;

FIG. 10 is a perspective view illustrating a relationship between a paper press belt and an image recording drum of an image recording section of an inkjet recording apparatus of a second exemplary embodiment;

FIG. 11A is a schematic view of a paper press pad and an image recording drum of an image recording section of an inkjet recording apparatus of a third exemplary embodiment, as viewed from an end face of the image recording drum;

FIG. 11B is a schematic view of a paper press pad and an image recording drum as viewed from a paper conveyance direction downstream side;

FIG. 12A is a schematic view of a paper press nozzle and an image recording drum of an image recording section of an inkjet recording apparatus of a fourth exemplary embodiment, as viewed from an end face of the image recording drum;

FIG. 12B is a schematic view of a paper press nozzle and an image recording drum as viewed from a paper conveyance direction downstream side;

FIG. 13 is a schematic view illustrating a configuration of a paper press roller (press roller) employed in a Comparative Example 1; and

FIG. 14 is a schematic view illustrating a configuration of a paper press roller (press roller) employed in a Comparative Example 2.

### DETAILED DESCRIPTION

### (1) First Exemplary Embodiment

Detailed explanation follows regarding a preferred exemplary embodiment of the present invention, with reference to the drawings.

Apparatus Configuration

An inkjet recording apparatus 1 that is an example of an image forming apparatus of the present invention is an inkjet recording apparatus for recording an image on paper P (a sheet form recording medium) by an inkjet method using water based UV inks (inks that use an aqueous medium and are cured with ultraviolet (UV) radiation). The inkjet recording apparatus 10 is configured so as to principally include: a paper feed section 12 for feeding the paper P that is an example of the sheet form recording medium; a process liquid application section 14 for applying a specific process liquid onto the front face (image recording face) of the paper P fed in from the paper feed section 12; a process liquid drying section 16 for drying the paper P applied with the process liquid by the process liquid application section 14; an image recording section 18 for recording an image with an inkjet method using water based UV inks on the front face of the paper P that has been subjected to drying by the process liquid drying section 16; an ink drying section 20 for drying the paper P recorded with an image by the image recording section 18; a UV irradiation section 22 for performing UV irradiation (fixing processing) to the paper P dried by the ink drying section 20 so as to fix images onto the paper P; and a paper discharge section 24 for discharging the paper P that has been irradiated with UV by the UV irradiation section 22

Paper Feed Section

The paper feed section 12 feeds paper P stacked on a paper feed plate 30 to the process liquid application section 14 one sheet at a time. The paper feed section 12 is configured so as to principally include: the paper feed plate 30; a sucker device 32; a pair of paper feed rollers 34; a feeder board 36; a front stop 38; and a paper feed drum 40.

The paper P is placed on the paper feed plate 30 in a bundle of multiple stacked sheets. The paper feed plate 30 is equipped with a paper feed plate raising and lowering device, not illustrated in the drawings, that is capable of raising and lowering the paper feed plate 30. The paper feed plate raising and lowering device is coordinated with increases and decreases in the paper P stacked on the paper feed plate 30, with drive of the paper feed plate raising and lowering device controlled so as to raise and lower the paper feed plate 30 such that the paper P positioned uppermost in the batch is always positioned at a constant height

The paper P serving as a sheet form recording medium is not particularly limited, and general purpose printing paper (paper principally formed from cellulose, such as what is referred to as premium grade paper, coated paper, or art paper) used in offset printing may be employed. In the present example, coating treated paper is employed. Coating treated paper is for example a paper coated with a coating material to provide a coating layer on a surface that is generally not surface treated, such as the surface of a premium grade paper or acid-free paper. Specifically, art paper, coated paper, lightly coated paper and finely coated paper are preferably employed.

In the paper feed section 12, the sucker device 32 picks up the paper P stacked on the paper feed plate 30 one sheet at a time in sequence from the top, and feeds the paper P to the pair of paper feed rollers 34. The paper P fed to the pair of paper feed rollers 34 is conveyed forwards by a pair of upper and lower rollers 34A, 34B configuring the paper feed rollers 34, and placed on the feeder board 36. The paper P placed on the feeder board 36 is conveyed by tape feeders 36A provided to the conveyance face of the feeder board 36. During this conveyance process, the conveyance face of the feeder board 36 is pressed by retainers 36B, correcting unevenness in the paper P. The orientation of the paper P being conveyed by the feeder board 36 is corrected due to a leading edge of the paper P contacting the front stop 38, after which the paper P is passed across to the paper feed drum 40. The paper P is then conveyed to the process liquid application section 14 by the paper feed drum 40.

Process Liquid Application Section

The process liquid application section 14 applies a specific process liquid to the front face (image recording face) of the paper P. The process liquid application section 14 is configured so as to principally include: a process liquid application drum 42 for conveying the paper P, and a process liquid application unit 44 for applying the specific process liquid to the printing face of the paper P being conveyed by the process liquid application drum 42.

Note that in the present example, configuration is made wherein the process liquid is coated by a roller, however the method for applying the process liquid is not limited thereto. Configuration may also be adopted wherein the process liquid is applied employing inkjet heads, or applied by spraying.

In the process liquid application section 14, the paper P passed across from the paper feed drum 40 of the paper feed section 12 is received by the process liquid application drum 42. The process liquid application drum 42 grips the leading edge of the paper P with the grippers 42A and rotates to convey the paper P wrapped around the peripheral face of the process liquid application drum 42. During this conveyance process, the coating roller 44A makes pressing contact with the front face of the paper P, coating the process liquid onto the front face of the paper P.

Note that the process liquid coated onto the front face of the paper P has a function of aggregating coloring matter in the water based UV inks that are dotted onto the paper P in the image recording section 18 at a later stage. Due to coating such a process liquid on the front face of the paper P and dotting on water based UV inks, pattern interference and the like can be avoided, enabling high quality printing to be performed even when general purpose printing paper is used.

Process Liquid Drying Section

The process liquid drying section 16 dries the paper P whose front face has been applied with process liquid. The process liquid drying section 16 is configured so as to principally include: a process liquid drying drum 46 for conveying the paper P; a paper conveyance guide 48; and process liquid drying units 50 for drying the process liquid by blowing hot air onto the printing face of the paper P being conveyed by the process liquid drying drum 46.

The process liquid drying section 16 is configured as described above. The paper P passed across from the process liquid application drum 42 of the process liquid application section 14 is received by the process liquid drying drum 46. The process liquid drying drum 46 grips the leading edge of the paper P with grippers 46A and rotates to convey the paper P. When this is performed, the process liquid drying drum 46 conveys the paper P with the front face (the face coated with the process liquid) facing inwards. The paper P is dried by blowing hot air from the process liquid drying units 50 disposed inside the process liquid drying drum 46 onto the front face of the paper P whilst the paper P is being conveyed by the process liquid drying drum 46. Namely the solvent component in the process liquid is driven off. An ink aggregation layer is accordingly formed on the front face of the paper P.

Image Recording Section

The image recording section 18 renders a color image on the printing face of the paper P by dotting liquid droplets of ink (water based UV ink) of colors C, M, Y, K onto the printing face of the paper P. The image recording section 18 is configured so as to principally include: an image recording drum 52 serving as an example of a conveyance body for conveying the paper P; a paper press roller 54 serving as an example of a pressing body for pressing the paper P conveyed by the image recording drum 52 so as to place the paper P in close contact with the peripheral face of the image recording drum 52; inkjet heads 56C, 56M, 56Y, 56K for jetting ink droplets of each color C, M, Y, K onto the paper P; an inline sensor 58 for reading an image recorded on the paper P; a mist filter 60 for trapping ink mist; and a drum cooling unit 62.

The image recording drum 52 receives the paper P from the process liquid drying drum 46 of the process liquid drying section 16 and conveys the paper P towards the ink drying section 20. The image recording drum 52 is formed in a circular cylindrical shape and is rotationally driven by a motor, not illustrated in the drawings. Grippers 52A are provided on the outer peripheral face of the image recording drum 52, and leading edges of the paper P are gripped by the grippers 52A. The image recording drum 52 conveys the paper P towards the ink drying section 20 by rotating with the leading edges of the paper P gripped by the grippers 52A and the paper P wrapped around the peripheral face of the image recording drum 52. The peripheral face of the image recording drum 52 is further provided with multiple suction holes (not illustrated in the drawings) that are formed in a specific pattern. The paper P wrapped around the peripheral face of the image recording drum 52 is conveyed whilst being suction retained to the peripheral face of the image recording drum 52 by the suction of the suction holes. The paper P can accordingly be conveyed with a high degree of flatness.

Note that the suction of the suction holes only acts over a certain range, acting between a specific suction start position to a specific suction end position. The suction start position is set as the disposal position of the paper press roller 54, and the suction end position is set at the downstream side of the disposal position of the inline sensor 58 (for example, set at the position where paper is passed across to the ink drying section 20). Namely, setting is made such that the paper P is suction retained to the peripheral face of the image recording drum 52 at least at the disposal positions of the inkjet heads 56C, 56M, 56Y, 56K (image recording positions) and the disposal position of the inline sensor 58 (image reading position).

Note that the mechanism for suction retention of the paper P to the peripheral face of the image recording drum 52 is not limited to the above negative pressure suction attachment method, and a method employing electrostatic attraction may also be adopted.

The image recording drum 52 of the present example is disposed with the grippers 52A at two locations on the outer peripheral face, in a configuration capable of conveying two sheets of the paper P with a single rotation. Rotation of the image recording drum 52 and the process liquid drying drum 46 is controlled such that the timings for receiving and passing across the paper P are coordinated with each other. Namely, the image recording drum 52 and the process liquid drying drum 46 are driven such that they have the same peripheral speed, and are driven such that the positions of the grippers are coordinated with each other.

The paper press roller 54 is disposed in the vicinity of the paper receiving position of the image recording drum 52 (the position where the paper P is received from the process liquid drying drum 46). The paper press roller 54 is configured from a rubber roller, and is disposed so as to be in pressing contact with the peripheral face of the image recording drum 52. The paper P that has been passed across to the image recording drum 52 from the process liquid drying drum 46 accordingly makes close contact with the peripheral face of the image recording drum 52 due to being nipped on passing the paper press roller 54.

Detailed explanation follows regarding configuration of the image recording drum 52 that serves as an example of a conveyance body (conveyance drum) of the present invention and the paper press roller 54 that serves as an example of a pressing body (press roller) of the present invention.

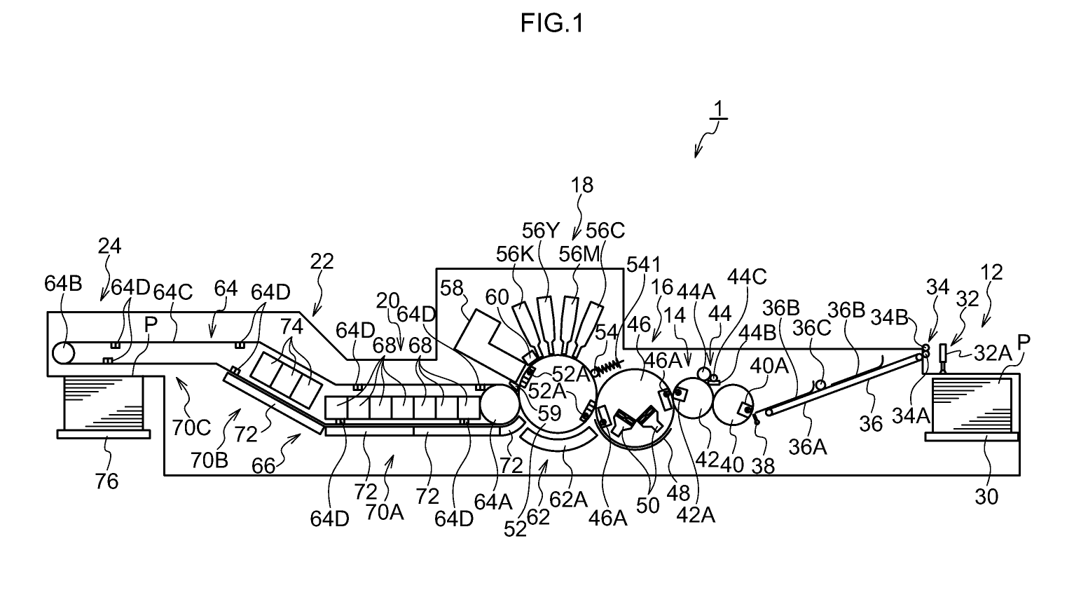

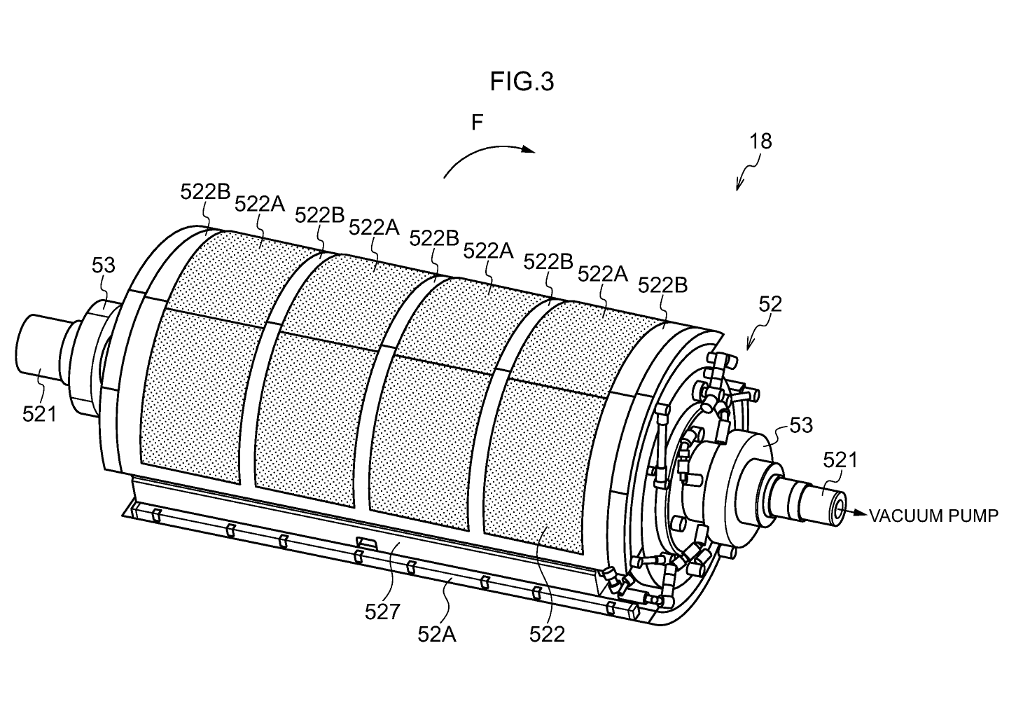

As illustrated in FIG. 3 to FIG. 5, a rotation shaft 521 is fixed at an axial center portion of the image recording drum 52. The rotation shaft 521 is supported by a shaft bearing 53 that is attached to the inkjet recording apparatus 1 illustrated in FIG. 1.

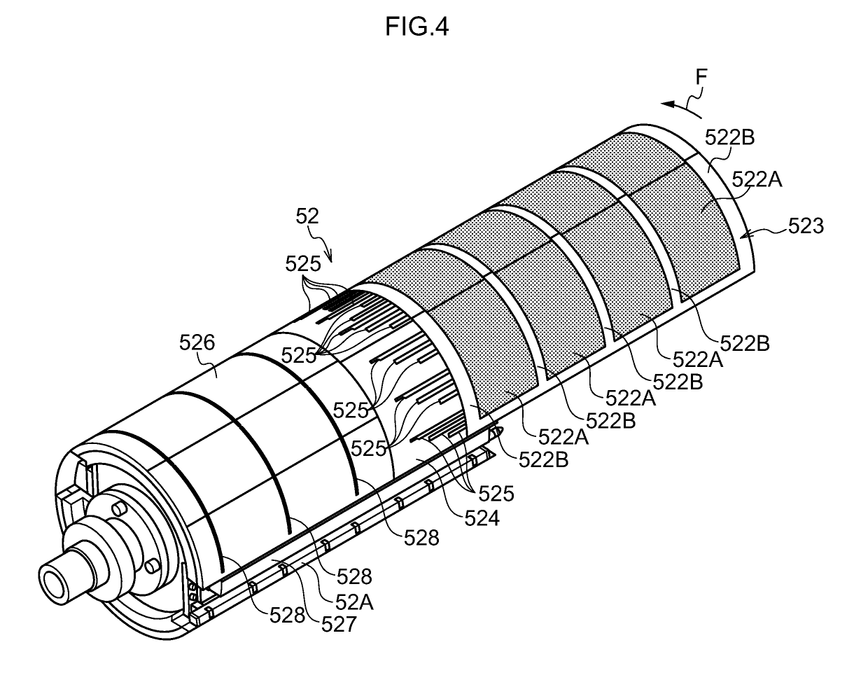

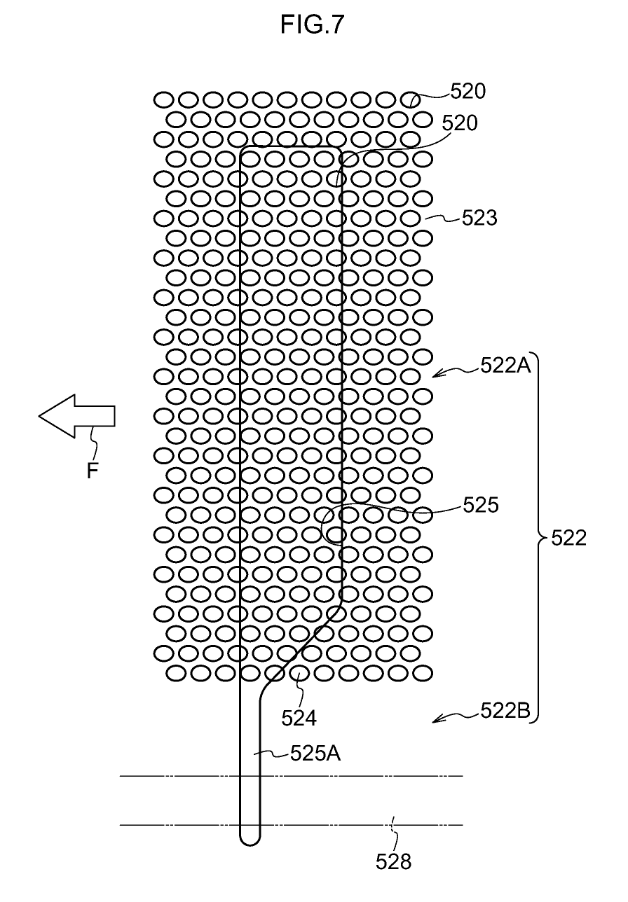

As illustrated in FIG. 3, FIG. 4 and FIG. 7, a suction adhesion face 522 on the peripheral face of the image recording drum 52 includes suction hole formed regions 522A onto which multiple suction holes 520 open, and suction hole unformed regions 522B in which the suction holes 520 are not provided. The suction hole unformed regions 522B are respectively provided at each of an axial direction central portion and both axial direction end portions of the image recording drum 52, and between the axial direction central portion and both axial direction end portions, to give a total of 5 locations. The suction hole unformed regions 522B are provided around the image recording drum 52 circumferential direction.

A vacuum path is formed inside the image recording drum 52 in communication with the suction holes 520. The vacuum path passes through the inside of the rotation shaft 521 of the image recording drum 52 and is in communication with a vacuum pump positioned to the outside of the image recording drum 52.

As illustrated in FIG. 4, the image recording drum 52 includes a suction adhesion sheet 523 of which an outside face configures a suction adhesion face 522, an intermediate sheet 524 provided to the inside of the suction adhesion sheet 523, and provided with suction adhesion grooves 525 that are in communication with the suction holes 520 that open onto the suction hole formed regions 522A, and a drum body 526 that is covered by the suction adhesion sheet 523 and the intermediate sheet 524. The drum body 526 corresponds to a barrel of the present invention.

Explanation follows regarding the suction adhesion sheet 523. As illustrated in FIG. 4 and FIG. 7, the suction adhesion sheet 523 is provided with the suction hole formed regions 522A and the suction hole unformed regions 522B, with the multiple suction holes 520 formed in the suction hole formed regions 522A. Accordingly, in a superimposed state of the suction adhesion sheet 523 and the intermediate sheet 524, the suction holes 520 are in communication with the suction adhesion grooves 525 as illustrated in FIG. 7. The suction holes 520 may be of an elliptical shape that is long in the paper P conveyance direction (arrow F) as illustrated in FIG. 7, or may be completely circular. The suction holes 520 may also be of a polygonal shape such as a hexagon shape. As illustrated in FIG. 7, the suction holes 520 are preferably disposed in a staggered formation with half-pitch positional displacement between suction holes 520 adjacent in the conveyance direction. Moreover, the diameter (the breadth in the case of polygonal shapes) of the suction holes 520 depends on the required suction force, however is preferably set in the region of 0.5 mm to 2 mm.

The suction adhesion sheet 523 has sufficient rigidity so as not to dent under suction pressure, and must be of a sufficient softness to be wrapped around the drum body 526. The thickness of the suction adhesion sheet 523 varies depending on the material, but is preferably set in the region of 0.1 mm to 0.5 mm.

Explanation follows regarding the intermediate sheet 524.

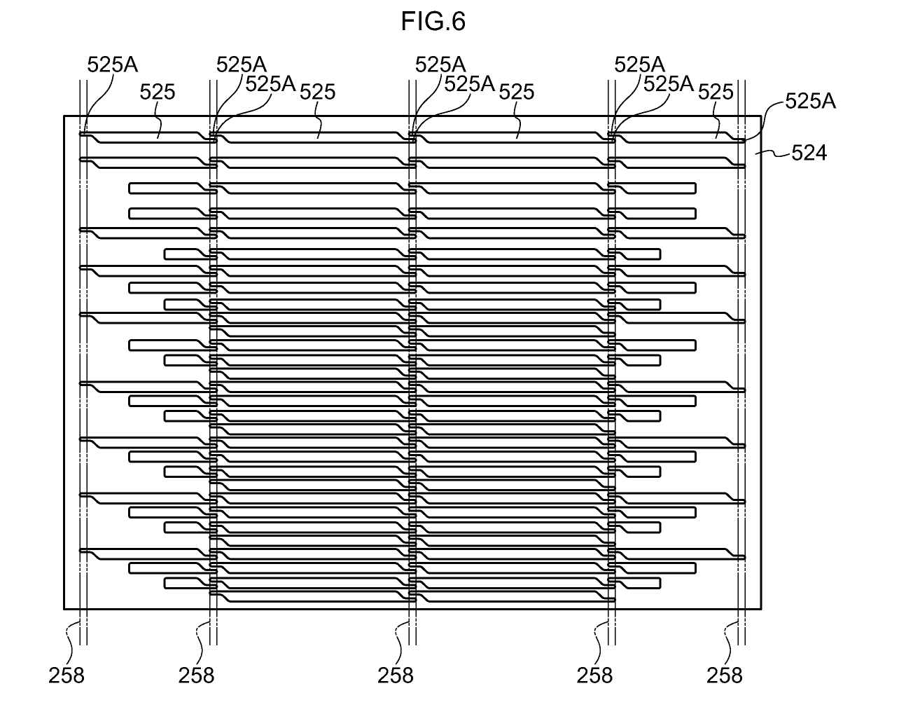

As illustrated in FIG. 4 and FIG. 6, the suction adhesion grooves 525 are provided running parallel to the axis of the image recording drum 52, and one or both ends of the suction adhesion grooves 525 are provided with narrowed portions 525A that are narrower in width than the suction adhesion grooves 525, serving as an example of flow path control portions of the present invention. The width of the narrowed portions 525A is set at ¼ of the width of the suction adhesion grooves 525 or below.

The width of the narrowed portions 525A is preferably within a range of 0.2 mm to 3.0 mm, and is more preferably within a range of 1.0 mm to 2.0 mm. The axial direction length of the narrowed portions 525A is preferably within a range of 2.0 mm to 10.0 mm.

A stronger suction force can be obtained with a smaller negative pressure the thinner the intermediate sheet 524. However, when the intermediate sheet 524 is too thin, the suction adhesion grooves 525 and the narrowed portions 525A readily become blocked due to foreign objects such as paper dust, rubbish and ink that have been sucked in through the suction holes 520. The thickness of the intermediate sheet 524 is therefore preferably set in the region of 0.05 mm to 0.5 mm.

As illustrated in FIG. 6, the suction adhesion grooves 525 are formed with a combination of different lengths corresponding to plural paper P sizes. In the example illustrated in FIG. 6, the suction adhesion grooves 525 are formed corresponding to 4 types of paper width. The pitch of the suction adhesion grooves 525 is preferably 50 mm or below.

As illustrated in FIG. 7, the suction adhesion sheet 523 is formed such that in a superimposed state of the intermediate sheet 524 and the suction adhesion sheet 523, the suction hole formed regions 522A cover the suction adhesion grooves 525, and the suction hole unformed regions 522B cover the narrowed portions 525A. In a superimposed state of the intermediate sheet 524 and the drum body 526, the suction holes 520 are accordingly in communication with the suction adhesion grooves 525, and the narrowed portions 525A are covered by the suction hole unformed regions 522B and are not in direct communication with the outside air.

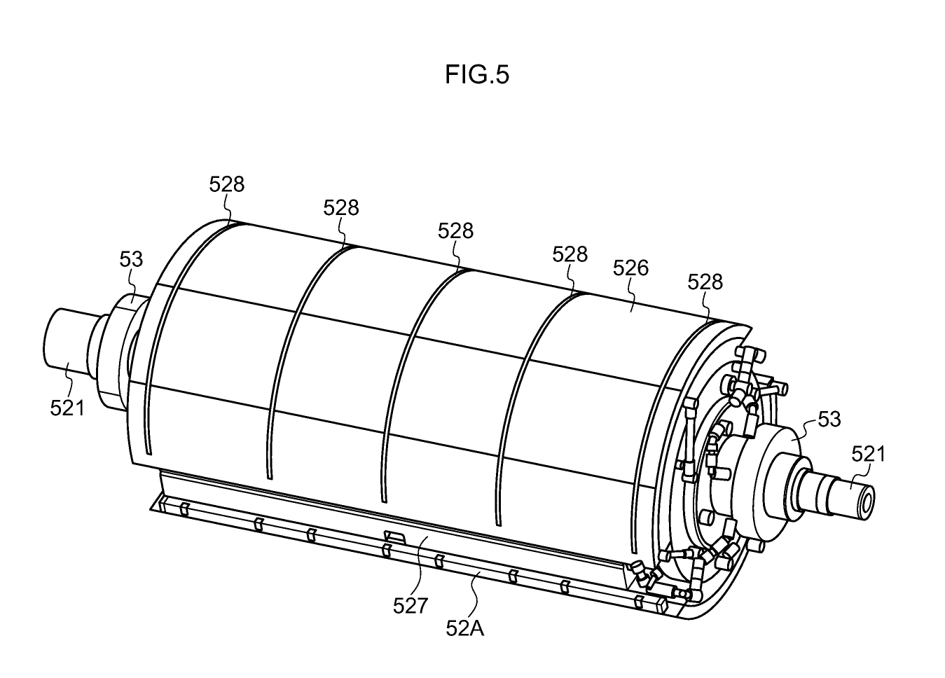

As illustrated in FIG. 5, 5 suction openings 528 extending around the drum body 526 circumferential direction are provided along the drum body 526 axial direction at positions corresponding to the narrowed portions 525A. The suction openings 528 are in communication with the narrowed portions 525A and configure portions of the vacuum path mentioned above. In FIG. 6 and FIG. 7, the positions of the suction openings 528 are indicated by the double-dashed broken lines. Note that as illustrated in FIG. 7, the width of the suction openings 528 is set at about ½ the width of the suction adhesion grooves 525. The drum body 526 is moreover provided with a gripper 527 for gripping the intermediate sheet 524 and the suction adhesion sheet 523. On the other side of the drum body 526 to the gripper 527, the intermediate sheet 524 and the suction adhesion sheet 523 that are gripped by the gripper 527 are provided with a pulling mechanism (not illustrated in the drawings) that applies tension force along the drum body 526 circumferential direction.

The image recording drum 52 is assembled in the following sequence.

First, the positions of the narrowed portions 525A of the intermediate sheet 524 and the positions of the suction openings 528 of the drum body 526 are aligned and the intermediate sheet 524 is entrained around and fixed to the drum body 526. Next, the suction adhesion sheet 523 is superimposed aligned with the intermediate sheet 524 such that the that the suction hole unformed regions 522B of the suction adhesion sheet 523 overlap with the narrowed portions 525A of the intermediate sheet 524, and the suction adhesion sheet 523 and the intermediate sheet 524 are fixed together.

In the image recording drum 52, the suction adhesion grooves 525 are in direct communication with the outside air through the suction holes 520, whereas the narrowed portions 525A are not in direct communication with the outside air due to being covered by the suction hole unformed regions 522B. The width of the narrowed portions 525A is ¼ or less of the width of the suction adhesion grooves 525. The narrowed portions 525A have a function of causing pressure drop in a flow path formed by the suction adhesion grooves 525 and the suction adhesion sheet 523. Accordingly, during suction conveyance of the paper P at a region of a portion of the suction hole formed regions 522A of the image recording drum 52, the narrowed portions 525A act to provide resistance as outside air is sucked into the vacuum system through the suction holes 520 that are present in regions of the suction hole formed regions 522A where the paper P is not suction adhered. This resistance to the flow of outside air that is being sucked in through the suction holes 520 open in the suction hole formed regions 522A towards the vacuum flow path inside the image recording drum 52 enables a large drop in the suction force of the paper P against the suction adhesion face 522 to be effectively prevented even when the paper P is suction adhered only to a region of a portion of the suction adhesion face 522, and even when the paper P is not suction adhered to the suction adhesion face 522 at all.

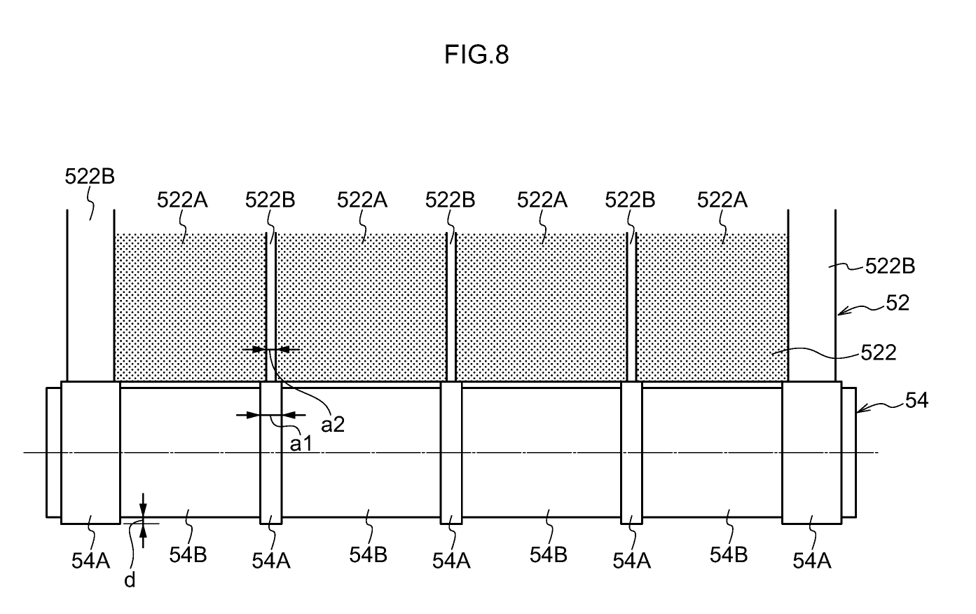

The paper press roller 54 is an example of a press roller of the present invention. As illustrated in FIG. 1, the paper press roller 54 is pressed against the suction adhesion face 522 of the image recording drum 52 by a pressing mechanism 541, and as illustrated in FIG. 8, the paper press roller 54 includes large diameter portions 54A provided at positions corresponding to the suction hole unformed regions 522B of the suction adhesion face 522, and small diameter portions 54B that are coaxial to the large diameter portions 54A and are smaller in diameter than the large diameter portions 54A. The large diameter portions 54A are an example of a strong pressing portion of the present invention, and the small diameter portions 54B are an example of a weak pressing portion of the present invention. As described above, the suction hole unformed regions 522B are respectively provided running around the image recording drum 52 circumferential direction, one each at an axial direction central portion and at both axial direction end portions of the image recording drum 52, and one each between the axial direction central portion and both axial direction end portions, to give a total of 5 locations. In the example illustrated in FIG. 8, the large diameter portions 54A are also respectively provided to the paper press roller 54 so as to run around the paper press roller 54 circumferential direction one each at an axial direction central portion and at both axial direction end portions of the of the paper press roller 54, and one each between the axial direction central portion and both axial direction end portions, to give a total of 5 locations. When the paper press roller 54 presses the suction adhesion face 522, the suction hole unformed regions 522B are accordingly pressed by the large diameter portions 54A, and the suction hole formed regions 522A are pressed by the small diameter portions 54B. The suction hole unformed regions 522B are therefore pressed more strongly by the paper press roller 54 than the suction hole formed regions 522A. Lift-off of the paper P from the suction adhesion face 522 at the suction hole unformed regions 522B can accordingly be prevented.

Note that in the example illustrated in FIG. 8, the width a1 of the large diameter portions 54A is set at between 2 and 3 times the width a2 of the suction hole unformed regions 522B. Lift-off of the paper P from the suction adhesion face 522 at the suction hole unformed regions 522B can accordingly be even more reliably prevented.

Note that in the example illustrated in FIG. 8, due to setting the width a1 of the large diameter portions 54A smaller than the width a2 of the suction hole unformed regions 522B, it is possible to prevent damage to the suction hole formed regions 522A and the paper P caused by excessive force acting on the suction hole formed regions 522A due to the large diameter portions 54A of the paper press roller 54 pressing the suction hole formed regions 522A as well as the suction hole unformed regions 522B.

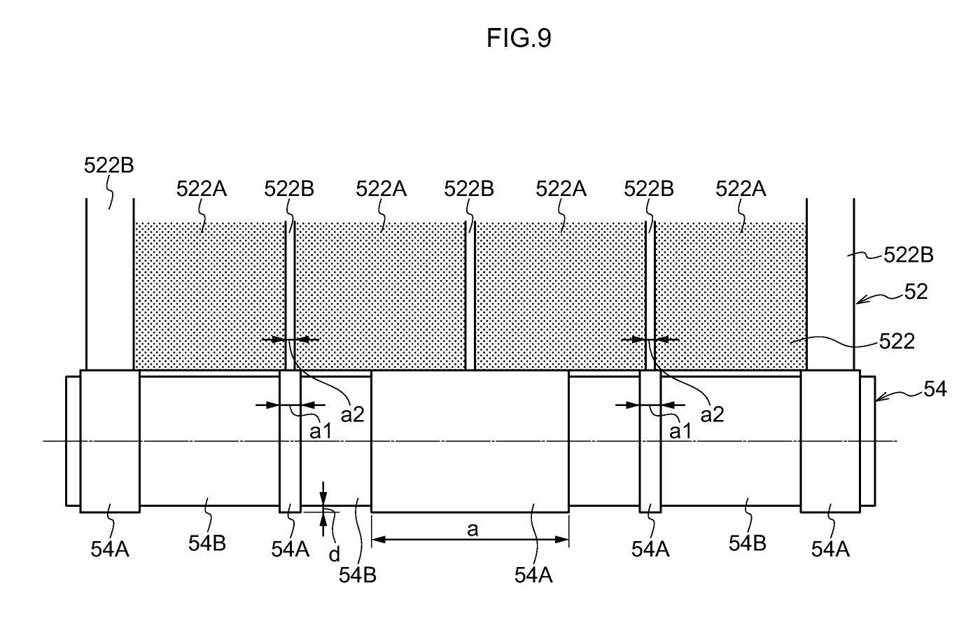

However as illustrated in FIG. 9, out of the large diameter portions 54A of the paper press roller 54, the large diameter portion 54A positioned at the axial direction central portion of the paper press roller 54 may be set with a larger width than the other large diameter portions 54A. Namely, in the example illustrated in FIG. 9, where LM is the width of the widest size, and Lm is the width of the narrowest size of paper P for conveyance, and a is the width of the large diameter portion 54A positioned at the axial direction central portion, the following expression is preferably satisfied:

0.2×LM≦a≦0.6×Lm

When the width a of the large diameter portion 54A positioned at the axial direction central portion satisfies the above relational expression, unevenness occurring at a width direction central portion of the paper P can be pressed out to both width direction edge portions even for the widest width paper P and the narrowest width paper P. Wide width paper P and narrow width paper P can accordingly be stably conveyed in the arrow F direction.

Moreover, in the examples illustrated in FIG. 8 and FIG. 9, when the height of a step between the large diameter portions 54A and the small diameter portions 54B of the paper press roller 54 is d, the step height d may also be said to be the distance from the paper P to the small diameter portions 54B, that are weak pressing portions, during conveyance of the paper P by the image recording drum 52.

Where Td is the distance from the ink jetting faces of the inkjet heads 56C, 56M, 56Y, 56K to the paper P being conveyed by the image recording drum 52, the step height d is set so as to satisfy the following expression:

0<d<Td

When the step height d of the paper press roller 54 is thus set, due to the distance d between the paper press roller 54 and the paper P being greater than 0, regions of the paper P corresponding to the small diameter portions 54B of the paper press roller 54 are accordingly non-pressed regions that are not pressed by the paper press roller 54. When unevenness is present in the paper P, the unevenness is accordingly pressed out into the non-pressed regions, thereby effectively preventing creasing caused by pressing. Moreover, since the distance d is smaller than the distance Td between the ink jetting faces of the inkjet heads 56C, 56M, 56Y, 56K and the paper P, even when lift-off of the paper P from the suction adhesion face 522 of the image recording drum 52 by the distance Td or more would otherwise have occurred, the lift-off is pressed down to the height d or less by the paper press roller 54. The paper P is accordingly prevented from making contact with the ink jetting faces.

The 4 inkjet heads 56C, 56M, 56Y, 56K are disposed at uniform intervals along the conveyance path of the paper P to the side of the image recording drum 52. The inkjet heads 56C, 56M, 56Y, 56K are configured as line heads corresponding to the paper width, with nozzle faces disposed facing the peripheral face of the image recording drum 52. Each of the inkjet heads 56C, 56M, 56Y, 56K jet liquid droplets of ink from nozzle rows formed on the nozzle faces towards the image recording drum 52, thereby recording an image on the paper P that is being conveyed by the image recording drum 52.

Note that as described above, water based UV inks are employed for the ink jetted from each of the inkjet heads 56C, 56M, 56Y, 56K. Water based UV inks can be cured by irradiation with ultraviolet radiation (UV) after being dotted.

The inline sensor 58 is disposed on the downstream side of the last of the inkjet heads 56K in the conveyance direction of the paper P by the image recording drum 52. The inline sensor 58 reads an image recorded on the paper P by the inkjet heads 56C, 56M, 56Y, 56K. The inline sensor 58 is configured by for example a line scanner, and reads the image recorded by the inkjet heads 56C, 56M, 56Y, 56K from the paper P that is being conveyed by the image recording drum 52.

The mist filter 60 is disposed between the last of the inkjet heads 56K and the inline sensor 58 so as to suck in air at the periphery of the image recording drum 52 and capture any ink mist. Ink mist is thereby suppressed from penetrating to the inline sensor 58 due to the air being sucked in at the periphery of the image recording drum 52 and any ink mist being captured, suppressing the occurrence of for example read errors.

The drum cooling unit 62 blows cool air onto the image recording drum 52, cooling the image recording drum 52. The drum cooling unit 62 is principally configured by an air conditioner (not illustrated in the drawings) and a duct 62A to blow cooled air supplied from the air conditioner onto the peripheral face of the image recording drum 52.

Note that the temperature to which the image recording drum 52 is cooled is determined based on a relationship with the temperature of the inkjet heads 56C, 56M, 56Y, 56K (in particular, the temperature of the nozzle faces), such that the image recording drum 52 is cooled to a lower temperature than the temperature of the inkjet heads 56C, 56M, 56Y, 56K. Condensation can accordingly be prevented from occurring on the inkjet heads 56C, 56M, 56Y, 56K. Namely, by lowering the temperature of the image recording drum 52 to below that of the inkjet heads 56C, 56M, 56Y, 56K, any condensation can be induced to occur on the image recording drum side, and condensation (in particular, condensation occurring on the nozzle face) can be prevented from occurring on the inkjet heads 56C, 56M, 56Y, 56K.

In the image recording section 18, the paper P passed across from the process liquid drying drum 46 of the process liquid drying section 16 is received by the image recording drum 52. The image recording drum 52 grips the leading edge of the paper P with the grippers 52A and rotates to convey the paper P. First of all, the paper P that has been passed across to the image recording drum 52 passes the paper press roller 54, thereby placing the paper P in close contact with the peripheral face of the image recording drum 52. At the same time, suction is applied through the suction holes of the image recording drum 52, such that the paper P is suction retained on the outer peripheral face of the image recording drum 52. The paper P is conveyed in this state, passing each of the inkjet heads 56C, 56M, 56Y, 56K. Liquid droplets of each color C, M, Y, K of ink are dotted onto the front face of the paper P from the respective inkjet heads 56C, 56M, 56Y, 56K as the paper P is passing, thereby rendering a color image on the front face. Feathering and bleeding, for example, do not occur since the ink aggregation layer has been formed on the front face of the paper P, enabling a high quality image to be recorded.

The paper P on which an image has been recorded by the inkjet heads 56C, 56M, 56Y, 56K then passes the inline sensor 58. The image recorded on the front face is read as the paper P passes the inline sensor 58. Such reading of the recorded image is performed as necessary, with the read image being inspected for jetting defects and the like. Here, reading is performed with the paper P in the suction retained state against the image recording drum 52, thereby enabling reading to be performed with high precision. Abnormalities such as jetting defects and the like can be detected immediately due to performing reading straight after image recording, enabling a swift response thereto. Unnecessary recording can accordingly be prevented, and wasted paper can be suppressed to a minimum.

After releasing the suction adhesion, the paper P is then passed across to the ink drying section 20.

Ink Drying Section

The ink drying section 20 dries the paper P after image recording, driving off the liquid component remaining on the front face of the paper P. The ink drying section 20 is configured by: a chain gripper 64 for conveying the paper P on which an image has been recorded; a back tension application mechanism 66 that applies back tension to the paper P being conveyed by the chain gripper 64; and ink drying units 68 that dry the paper P being conveyed by the chain gripper 64.

The chain gripper 64 is a common paper conveyance mechanism employed in the ink drying section 20, the UV irradiation section 22, and the paper discharge section 24. The chain gripper 64 receives the paper P passed across from the image recording section 18 and conveys it as far as the paper discharge section 24.

Chain guides are disposed at specific positions, and guide such that chains 64C provided to the chain gripper 64 travel along specific paths. The chain guides are configured by a first horizontal conveyance path 70A, an inclined conveyance path 70B, and a second horizontal conveyance path 70C.

In the ink drying section 20, the paper P passed across from the image recording drum 52 of the image recording section 18 is received by the chain gripper 64. The chain gripper 64 grips the leading edge of the paper P with the grippers 64D and conveys the paper P along a flat plane shaped first guide plate 72. The paper P that has been passed across to the chain gripper 64 is first conveyed over the first horizontal conveyance path 70A. Whilst being conveyed over the first horizontal conveyance path 70A, the paper P is dried by the ink drying units 68 disposed inside the chain gripper 64. Namely, drying is performed by blowing hot air against the front face (the image recorded face). The paper P is dried here whilst being applied with back tension by the back tension application mechanism 66. Deformation of the paper P can accordingly be suppressed whilst drying.

UV Irradiation Section

The UV irradiation section 22 irradiates ultraviolet radiation (UV) onto an image recorded using the water based UV ink, thereby fixing the image. The UV irradiation section 22 is principally configured by the chain gripper 64 that conveys the dried paper P, the back tension application mechanism 66 that applies back tension to the paper P being conveyed by the chain gripper 64, and UV irradiation units 74 that irradiate ultraviolet radiation onto the paper P being conveyed by the chain gripper 64.

The chain gripper 64 and back tension application mechanism 66 are commonly employed in the ink drying section 20 and the paper discharge section 24.

In the UV irradiation section 22, the paper P that is being conveyed by the chain gripper 64 and has been dried by the ink drying section 20 is next conveyed over the inclined conveyance path 70B. Whilst being conveyed over the inclined conveyance path 70B, the paper P is irradiated with UV by the UV irradiation units 74 installed to the inside of the chain gripper 64.

Paper Discharge Section

The paper discharge section 24 collects the paper P that has been subjected to a cycle of image recording processing. The paper discharge section 24 is principally configured by the chain gripper 64 for conveying the UV irradiated paper P, and a paper discharge plate 76 for stacking and collecting the paper P.

As described above, the chain gripper 64 is commonly employed in the ink drying section 20 and the UV irradiation section 22. The chain gripper 64 releases the paper P over the paper discharge plate 76, stacking the paper P on the paper discharge plate 76.

The paper discharge plate 76 stacks and collects the paper P released from the chain gripper 64. The paper discharge plate 76 is provided with paper stops (for example a front paper stop, a rear paper stop, and side paper stops) (not illustrated in the drawings) so as to stack the paper P neatly.

The paper discharge plate 76 is further equipped with a paper discharge plate raising and lowering device, not illustrated in the drawings, that is capable of raising and lowering the paper discharge plate 76. The paper discharge raising and lowering device is coordinated with increases and decreases in the amount of the paper P stacked in the paper discharge plate 76, with drive controlled so that the paper discharge plate 76 is raised and lowered such that the uppermost sheet of paper P is always positioned at a constant height.

Control Section

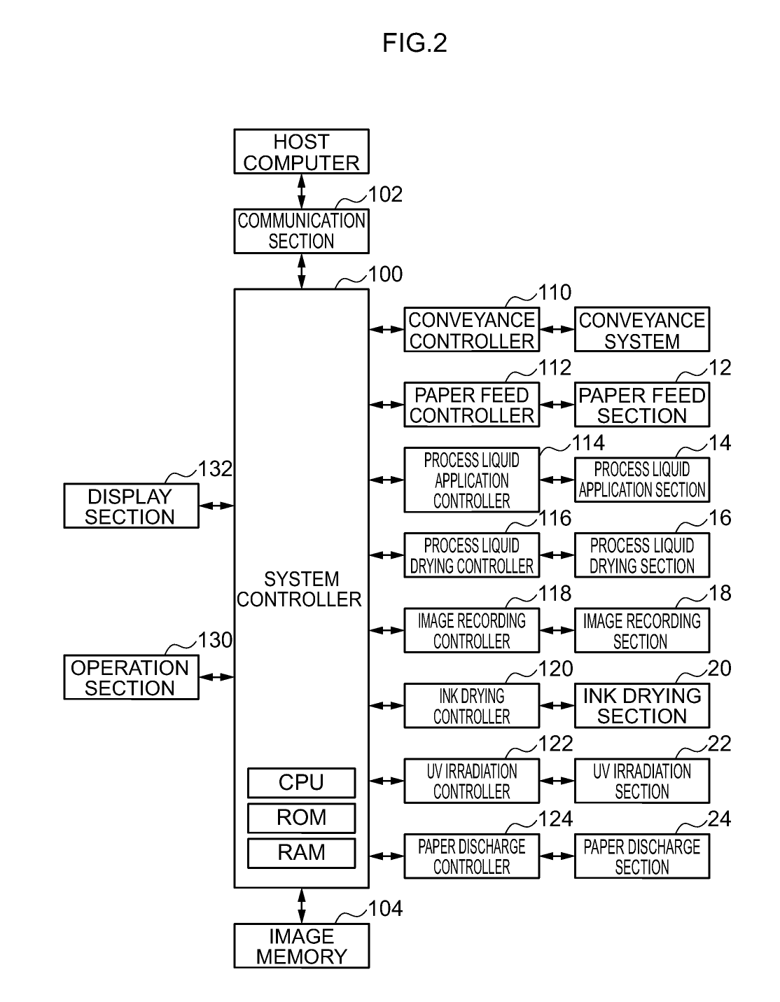

As illustrated in FIG. 2, the inkjet recording apparatus 1 is provided with sections including a system controller 100, a communication section 102, an image memory 104, a conveyance controller 110, a paper feed controller 112, a process liquid application controller 114, a process liquid drying controller 116, an image recording controller 118, an ink drying controller 120, a UV irradiation controller 122, a paper discharge controller 124, an operation section 130, and a display section 132.

The system controller 100 functions as a control component for performing overall control of each section of the inkjet recording apparatus 1, and also functions as a computation component for performing various computation. The system controller 100 includes for example a CPU, ROM, and RAM, and operates according to a specific control program. The ROM is stored with a control program that is executed by the system controller 100 and also with various data that is required for control.

The communication section 102 includes a necessary communication interface, and performs transmission between the communication section 102 and a host computer connected to the communication interface.

The image memory 104 functions as temporary storage component for various data including image data, and performs reading and writing of data through the system controller 100. Image data acquired from the host computer through the communication section 102 is stored in the image memory 104.

The conveyance controller 110 controls a paper P conveyance system of the inkjet recording apparatus 1. Namely, the conveyance controller 110 controls drive of the tape feeders 36A, the front stop 38, and the paper feed drum 40 of the paper feed section 12, and respectively controls drive of the process liquid application drum 42 of the process liquid application section 14, the process liquid drying drum 46 of the process liquid drying section 16, and the image recording drum 52 of the image recording section 18. The conveyance controller 110 moreover controls drive of the chain gripper 64 and the back tension application mechanism 66 that are commonly employed in the ink drying section 20, the UV irradiation section 22 and the paper discharge section 24.

The conveyance controller 110 controls the conveyance system according to instruction from the system controller 100 such that the paper P is conveyed without stopping from the paper feed section 12 to the paper discharge section 24.

The paper feed controller 112 controls the paper feed section 12 according to instruction from the system controller 100. Specifically, the paper feed controller 112 controls drive of for example the sucker device 32 and the paper feed plate raising and lowering device, performing control such that the paper P stacked on the paper feed plate 30 is fed in sequence one sheet at a time without overlapping.

The process liquid application controller 114 controls the process liquid application section 14 according to instruction from the system controller 100. Specifically, the process liquid application controller 114 controls drive of the process liquid application unit 44 such that the paper P being conveyed by the process liquid application drum 42 is coated with the process liquid.

The process liquid drying controller 116 controls the process liquid drying section 16 according to instruction from the system controller 100. Specifically, the process liquid drying controller 116 controls drive of the process liquid drying units 50 such that the paper P being conveyed by the process liquid drying drum 46 is dried.

The image recording controller 118 controls the image recording section 18 according to instruction from the system controller 100. Specifically, the image recording controller 118 controls drive of the inkjet heads 56C, 56M, 56Y, 56K such that a specific image is recorded on the paper P being conveyed by the image recording drum 52. The image recording controller 118 moreover controls actuation of the inline sensor 58 such that the recorded image is read.

The ink drying controller 120 controls the ink drying section 20 according to instruction from the system controller 100. Specifically, the ink drying controller 120 controls drive of the ink drying units 68 such that hot air is supplied to the paper P being conveyed by the chain gripper 64.

The UV irradiation controller 122 controls the UV irradiation section 22 according to instruction from the system controller 100. Specifically, the UV irradiation controller 122 controls drive of the UV irradiation units 74 such that the paper P being conveyed by the chain gripper 64 is irradiated with ultraviolet radiation.

The paper discharge controller 124 controls the paper discharge section 24 according to instruction from the system controller 100. Specifically, the paper discharge controller 124 controls drive of for example the paper discharge plate raising and lowering device, performing control such that the paper P is stacked on the paper discharge plate 76.

The operation section 130 is provided with an appropriate operation component (for example operation buttons or a keyboard, or a touch panel), and outputs to the system controller 100 operation data input through the operation component. The system controller 100 performs various processing according to the operation data input from the operation section 130.

The display section 132 is provided with an appropriate display device (for example an LCD panel), and displays appropriate information on the display device according to instruction from the system controller 100.

As described above, the inkjet recording apparatus 1 acquires image data for recording on the paper from the host computer through the communication section 102. The acquired image data is stored in the image memory 104.

The system controller 100 performs appropriate signal processing on the image data stored in the image memory 104 to generate dot data. The system controller 100 controls drive of the respective inkjet heads 56C, 56M, 56Y, 56K of the image recording section 18 according to the generated dot data, thereby recording on the paper an image expressed by the image data.

Dot data is generally generated by performing color conversion processing and halftone processing on image data. Color conversion processing is for example processing wherein image data expressed by for example sRGB (for example RGB 8-bit image data) is converted into ink amount data for each ink color employed in the inkjet recording apparatus 1 (in the present example, converted into ink amount data for each color of C, M, Y, K). Halftone processing is processing wherein for example error diffusion is performed on the ink amount data of each color generated by the color conversion processing, thereby converting the ink amount data into dot data for each color.

The system controller 100 performs color conversion processing and halftone processing on the image data to generate the dot data for each color. Based on the generated dot data for each color, the system controller 100 then controls drive of the corresponding inkjet heads to record an image expressed by the image data on the paper.

Operation

Explanation follows regarding operation of the inkjet recording apparatus 1 of the first exemplary embodiment. The paper P that has been fed from the paper feed section 12, applied with the process liquid by the process liquid application section 14, and dried by the process liquid drying section 16 is passed across from the process liquid drying drum 46 of the process liquid drying section 16 to the image recording drum 52 of the image recording section 18. In the image recording section 18, the paper P is conveyed towards the inkjet heads 56C, 56M, 56Y, 56K in a suction retained state on the image recording drum 52 and in a state pressed by the paper press roller 54 or a paper press belt 55. Liquid droplets of ink of each color C, M, Y, K are dotted on the front face by the inkjet heads 56C, 56M, 56Y, 56K, thereby recording an image.

The paper P that has been recorded with an image in the image recording section 18 is conveyed to the ink drying section 20 where the ink is dried, and then UV irradiated in the UV irradiation section 22 to cure the ink, after which the paper P is discharged by the paper discharge section 24.

### (2) Second Exemplary Embodiment

An inkjet recording apparatus according to a second exemplary embodiment is similar in configuration to the inkjet recording apparatus 1 of the first exemplary embodiment illustrated in FIG. 1, with the exception that a paper press belt 55 is employed in the place of the paper press roller 54 in the image recording section 18.

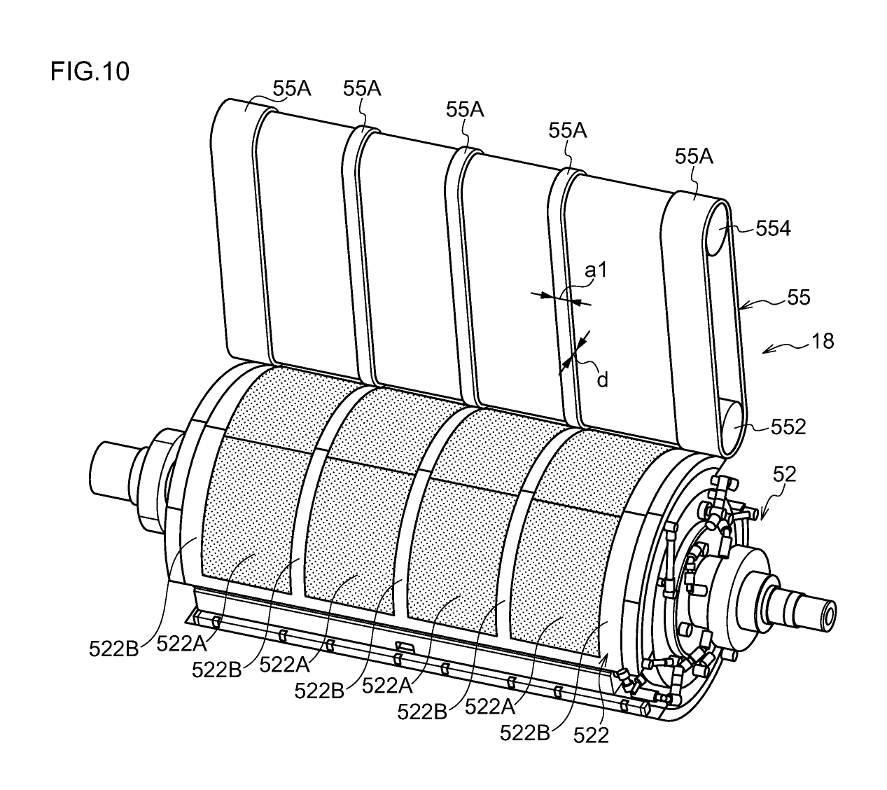

The paper press belt 55 is an example of a pressing belt of the present invention. As illustrated in FIG. 10, the paper press belt 55 spans between a stretch roller 552 and a stretch roller 554. The paper press belt 55 is pressed against the suction adhesion face 522 of the image recording drum 52 by the pressing mechanism 541 illustrated in FIG. 1. The paper press belt 55 rotates to follow rotation of the image recording drum 52 in the direction indicated by the arrow F.

As illustrated in FIG. 10, an outer peripheral face of the paper press belt 55 is formed with 5 projecting portions 55A around the paper press belt 55 circumferential direction at positions corresponding to the suction hole unformed regions 522B of the suction adhesion face 522. The projecting portions 55A are accordingly respectively provided running along the paper press belt 55 circumferential direction, one each at a width direction central portion and both width direction end portions of the paper press belt 55, and also one each between the width direction central portion and both width direction end portions, to give a total of 5 locations. The height d and width a1 of the projecting portions 55A are set similarly to as explained regarding the width a1 of the large diameter portions 54A, and the step height d between the large diameter portions 54A and the small diameter portions 54B, in the paper press roller 54 of the first exemplary embodiment that are illustrated in FIG. 8 and FIG. 9.

Accordingly, when the paper press belt 55 is pressed against the suction adhesion face 522, the suction hole unformed regions 522B are pressed by the projecting portions 55A, and the suction hole formed regions 522A are pressed by small diameter portions. The paper press belt 55 accordingly presses the suction hole unformed regions 522B more strongly than the suction hole formed regions 522A. Lift-off of the paper P from the suction adhesion face 522 at the suction hole unformed regions 522B can accordingly be prevented.

Moreover, similarly to the paper press roller 54, the paper press belt 55 may be configured such that the width of the projecting portion 55A positioned at the width direction central portion is greater than the width of the other 4 projecting portions 55A. In such cases, where LM is the width of the widest size, and Lm is the width of the narrowest size of the paper P for conveyance, the width a of the projecting portion 55A positioned at the width direction central portion preferably satisfies the following expression:

0.2×LM≦a≦0.6×Lm

When the width a of the projecting portion 55A positioned at the axial direction central portion satisfies the above relational expression, unevenness occurring at a width direction central portion of the paper P can be pressed out at both width direction edge portions even for the widest width paper P and the narrowest width paper P. Wide width paper P and narrow width paper P can accordingly be stably conveyed in the arrow F direction.

Moreover, where d is the height of the projecting portions 55A of the paper press belt 55, and Td is the distance between the ink jetting faces of the inkjet heads 56C, 56M, 56Y, 56K and the paper P being conveyed suction adhered to the image recording drum 52, the projecting portion height d is set so as to satisfy the following expression:

0<d<Td

Accordingly, for similar reasons to those described in the first exemplary embodiment, the occurrence of creasing caused by unevenness in the paper P, and problems due to the paper P making contact with the ink jetting faces, can be avoided.

### (3) Third Exemplary Embodiment

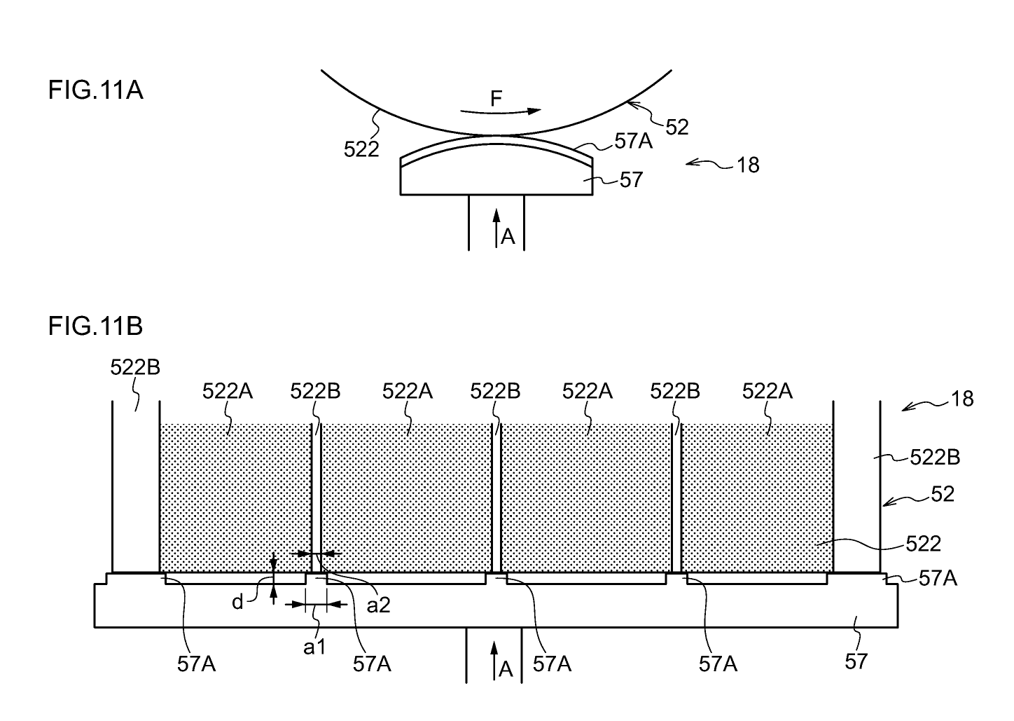

As illustrated in FIG. 11A, an inkjet recording apparatus 3 according to a third exemplary embodiment has a similar configuration to the inkjet recording apparatus 1 of the first exemplary embodiment illustrated in FIG. 1, with the exception that a paper press pad 57 is employed in place of the paper press roller 54 in the image recording section 18. The paper press pad 57 is an example of a contact pressing body of the present invention.

As indicated by the arrow A in FIG. 11A, the paper press pad 57 presses against the suction adhesion face 522 of the image recording drum 52. The paper press pad 57 is an example of a contact pressing body of the present invention. A face of the paper press pad 57 on the side that contacts the suction adhesion face 522 is formed from a low friction material such as a fluorine resin or an ultrahigh molecular weight polyethylene resin. As illustrated in FIG. 11A and FIG. 11B, the paper press pad 57 is formed with projecting portions 57A at positions corresponding to the suction hole unformed regions 522B. The height and width of the projecting portions 55A are set similarly to as has been explained regarding the width a1 of the large diameter portions 54A and the step height d between the large diameter portions 54A and the small diameter portions 54B of the paper press roller 54 of the first exemplary embodiment, as illustrated in FIG. 8 and FIG. 9.

Moreover, where d is the height of the projecting portions 57A of the paper press pad 57, and Td is the distance between the ink jetting faces of the inkjet heads 56C, 56M, 56Y, 56K and the paper P being conveyed suction adhered to the image recording drum 52, the projecting portion height d is set so as to satisfy the following expression:

0<d<Td

Accordingly, for similar reasons to those described in the first exemplary embodiment, the occurrence of creasing caused by unevenness in the paper P, and problems due to the paper P making contact with the ink jetting faces, can be avoided.

### (4) Fourth Exemplary Embodiment

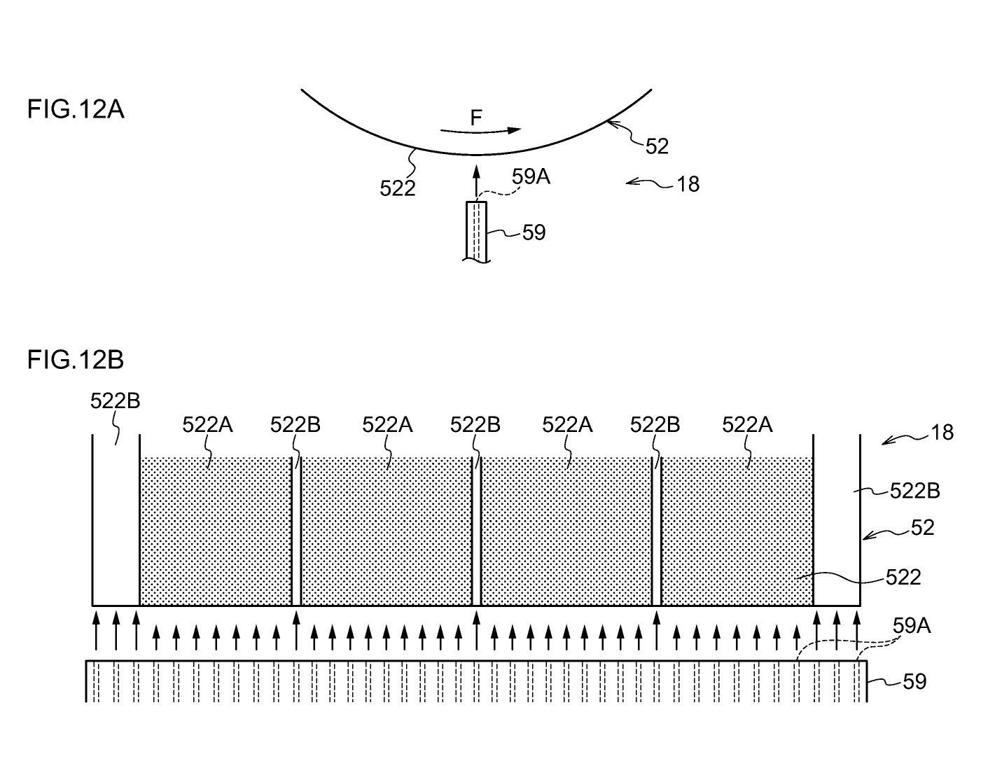

As illustrated in FIG. 12, an inkjet recording apparatus 4 according to a fourth exemplary embodiment has a similar configuration to the inkjet recording apparatus 1 of the first exemplary embodiment illustrated in FIG. 1, with the exception that a paper press nozzle 59 is employed in place of the paper press roller 54 in the image recording section 18.

As illustrated in FIG. 12A and FIG. 12B, the paper press nozzle 59 is provided along the image recording drum 52 axial direction, with multiple airflow blowing holes 59A that blow air towards the suction adhesion face 522 opening along the paper press nozzle 59 length direction. Airflow blowing holes 59A that face the suction hole unformed regions 522B blow a stronger airflow than the airflow blowing holes 59A that face to the suction hole formed regions 522A.

The suction hole unformed regions 522B are accordingly pressed harder than the suction hole formed regions 522A by the airflow blown out from the airflow blowing holes 59A.

In the above explanation, the examples given are employed in the image recording section 18 in the inkjet recording apparatus 1 to 4, however the conveyance apparatus of the present invention is not limited to use in the image recording section 18, and the conveyance apparatus of the present invention may also be used at other locations where the paper P is conveyed by a drum, such as in the process liquid application section 14 and the process liquid drying section 16. Explanation has been given of embodiments wherein the image recording drum 52 suction adheres the paper P to the suction adhesion face 522 employing vacuum pressure, however the image recording drum 52 may also employ electrostatic attraction to adhere the paper P to the suction adhesion face 522.

### EXAMPLE

### (1) Examples 1, 2, Comparative Examples 1, 2

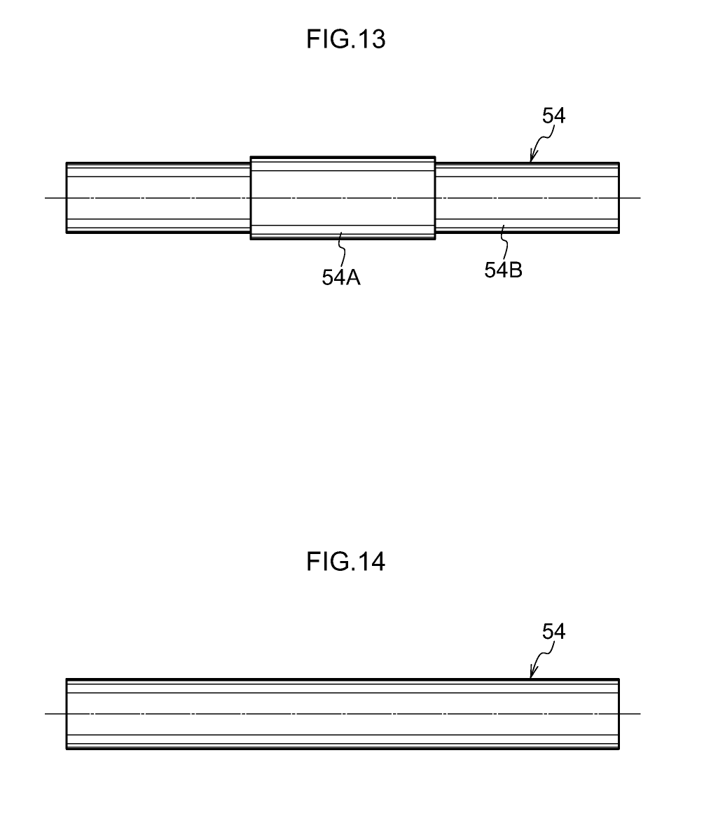

For the inkjet recording apparatus 1 of the first exemplary embodiment, Example 1 employs the paper press roller 54 illustrated in FIG. 8, and Example 2 employs the paper press roller 54 illustrated in FIG. 9. Comparative Example 1 employs the paper press roller 54 illustrated in FIG. 13 with the large diameter portion 54A formed at the axial direction central portion only. Comparative Example 2 employs the circular cylinder shaped paper press roller 54 illustrated in FIG. 14 that does not include a large diameter portion. Results are illustrated in Table 1.

TABLE 1

| | Paper press roller | | |
|---|---|---|---|
| | shape | Result | Comments |
| Example 1 | 5 large diameter | GOOD | Good suction adhesion |
| | portions, all of | | even with high droplet |
| | similar width | | amount forced images |
| | (FIG. 8) | | |
| Example 2 | Central portion large | GOOD/ | Normal images OK. |
| | diameter portion has | PASSABLE | Cockling occurs with |
| | greater width than | | high droplet amount |
| | both side portion | | forced images |
| | large diameter | | |
| | portions (FIG. 9) | | |
| Comparative | Large diameter | PASSABLE | No cockling at paper |
| Example 1 | portion at central | | rear edge center, |
| | portion only | | however slight lift-off |
| | | | at narrowed portions |
| Comparative | No large diameter | NG | Cockling at paper rear |
| Example 2 | portions | | edge center |

(Note that height difference between large diameter portions and small diameter portions is 0.1 mm)

As illustrated in Table 1, in Example 1 cockling of the paper P is not observed in normal images or in forced images that have a higher droplet amount than normal images. In Example 2, although slight cockling of the paper P is confirmed with forced images, cockling of the paper P is not observed in normal images.

However, in Comparative Example 1, although in normal images cockling is not observed at a central portion of the paper P, some slight lift-off is observed at portions where the paper P adheres to the suction hole unformed regions 522B of the image recording drum 52. In Comparative Example 2, the cockling occurrence is observed at a central portion of the paper P even in normal images.

It can accordingly be seen that employing the paper press roller 54 formed with the large diameter portions 54A corresponding to the suction hole unformed regions 522B of the image recording drum 52 as illustrated in FIG. 8 and FIG. 9 enables the occurrence of cockling in the paper P to be effectively prevented.

### EXPLANATION OF THE REFERENCE NUMERALS

What is claimed is:

1. A conveyance apparatus comprising:
a conveyance body that suction adheres and conveys a sheet form medium; and
a pressing body that presses the sheet form medium against a suction adhesion face of the conveyance body that suction adheres the sheet form medium, the pressing body pressing more strongly portions of the suction adhesion face at a plurality of locations along the suction adhesion face width direction where suction adhesion force is weaker than the pressing body presses other portions.

2. The conveyance apparatus of claim 1, wherein the pressing body is a contact pressing body that contacts and presses the suction adhesion face of the conveyance body, and the pressing body includes a strong pressing portion that is closer to the conveyance body and a weak pressing portion that is further away from the conveyance body.

3. The conveyance apparatus of claim 2, wherein the contact pressing body is a rotating pressing body that rotates whilst contacting the conveyance body.

4. The conveyance apparatus of claim 1, wherein:
the conveyance body is a conveyance drum that rotates about an axis; and
the conveyance drum suction adhesion face is partitioned along the conveyance drum axial direction into a suction hole formed region where multiple suction holes are formed, and a suction hole unformed region where suction holes are not formed.

5. The conveyance apparatus of claim 4, wherein:
the pressing body is a rotating pressing body; and
a strong pressing portion of the rotating pressing body presses the suction hole unformed region of the conveyance drum, and a weak pressing portion of the rotating pressing body presses the suction hole formed region of the conveyance drum.

6. The conveyance apparatus of claim 5, wherein the width of the strong pressing portion of the rotating pressing body is greater than the width of the suction hole unformed region of the conveyance drum.

7. The conveyance apparatus of claim 5, wherein the width of the strong pressing portion of the rotating pressing body is smaller than the width of the suction hole unformed region of the conveyance drum.

8. The conveyance apparatus of claim 3, wherein:
the rotating pressing body is a press roller;
the press roller is formed with a plurality of large diameter portions that are the rotating pressing body strong pressing portions, and a small diameter portion that is the rotating pressing body weak pressing portion and has a smaller external diameter than the large diameter portions.

9. The conveyance apparatus of claim 3, wherein:
the rotating pressing body is a press belt;
a face of the press belt on a side that presses the sheet form medium is formed with a plurality of projecting portions running in the press belt rotation direction; and
portions of the press belt formed with the projecting portions configure the rotating pressing body strong pressing portions, and a portion of the press belt not formed with the projecting portions configures the rotating pressing body weak pressing portion.

10. The conveyance apparatus of claim 4, wherein the conveyance drum comprises:
a barrel provided with a plurality of suction openings passing through to an inside negative pressure portion, the suction openings formed in an outer peripheral face around the circumferential direction;
an intermediate sheet that is mounted to an outer peripheral face of the barrel, and that is provided with a plurality of suction adhesion grooves around the barrel circumferential direction, the suction adhesion grooves extending in the axial direction and including narrowed portions facing the suction openings of the barrel; and
a suction adhesion sheet that is mounted to an outside face of the intermediate sheet and that configures the suction adhesion face, with the suction holes formed in the suction hole formed region of the suction adhesion face being in communication with the suction adhesion grooves, and with the suction hole unformed region facing the narrowed portions.

11. An image forming apparatus comprising:
the conveyance apparatus of claim 1 that suction adheres and conveys a sheet form medium on a suction adhesion face; and
a liquid droplet jetting head that jets liquid droplets onto the sheet form medium that is being conveyed by the conveyance apparatus.

12. An image forming apparatus comprising:
the conveyance apparatus of claim 1 that suction adheres and conveys a sheet form medium on a suction adhesion face; and
a liquid droplet jetting head that jets liquid droplets onto the sheet form medium that is being conveyed by the conveyance apparatus, wherein
d is a distance between the weak pressing portion of the pressing body and the sheet form medium when the sheet form medium is being conveyed by the conveyance apparatus,
Td is a distance between a liquid droplet jetting face of the liquid droplet jetting head and the sheet form medium, and
the distance d is set so as to satisfy the expression
0<d<Td

13. An image forming apparatus comprising:
the conveyance apparatus of claim 8 that suction adheres and conveys a sheet form medium on a suction adhesion face; and
a liquid droplet jetting head that jets liquid droplets onto the sheet form medium that is being conveyed by the conveyance apparatus, wherein
d is a height d of a step between the large diameter portions and the small diameter portion of the press roller,
Td is a distance between a liquid droplet jetting face of the liquid droplet jetting head and the sheet form medium, and
the distance d is set so as to satisfy the expression
0<d<Td

14. An image forming apparatus comprising:
the conveyance apparatus of claim 9 that suction adheres and conveys a sheet form medium on a suction adhesion face; and
a liquid droplet jetting head that jets liquid droplets onto the sheet form medium that is being conveyed by the conveyance apparatus, wherein
d is a height d of the projecting portions of the press belt,
Td is a distance between a liquid droplet jetting face of the liquid droplet jetting head and the sheet form medium, and
the distance d is set so as to satisfy the expression
0<d<Td
